(19) United States
(12) Patent Application Publication
(10) Pub. No.: US 2010/0181893 A1
(43) Pub. Date: Jul. 22, 2010

(54) INTERSECTING ELECTRODE ELECTRON EMITTER

(76) Inventor: Alireza Ousati Ashtiani, Tehran (IR)

Correspondence Address: PATWRITE LLC, 408 W. MAIN ST., MARSHALLTOWN, IA, 50158-5759, US

(21) Appl. No.: 12/689,261

(22) Filed: Jan. 19, 2010

Related U.S. Application Data
(60) Provisional application No. 61/145,191, filed on Jan. 16, 2009.

(51) Int. Cl. H01J 1/92; C23F 1/02

(52) U.S. Cl. 313/243; 216/41

(57) ABSTRACT

A novel electron emitting device that has a small fissure to realize electron emission. Thin electrodes of anode and cathode of this novel emitter are not coplanar, instead they are placed on 2 intersecting surface and anode-cathode fissure is placed on top or near the top edge of these two intersecting surfaces. Preferably, the shape of the substrate is a 3-dimentional object with cylindrical shape with a cross section similar to triangle, bell shape or 2 intersecting parabolic curves (final shape of the substrate is somehow wedge shaped).

### CROSS REFERENCE TO RELATED APPLICATIONS

This application claims priority and herein incorporates by reference U.S. provisional patent application 61145191, filed Jan. 16, 2009.

### BACKGROUND OF THE INVENTION

One of main hurdles of realizing practical field emission displays (or other vacuum microelectronic devices) is the fact that prior art electron emitters were not durable enough, needed high voltage to operate, couldn't be mass produced and had other weaknesses. Older emitters were usually spindt type emitters and later, other candidates like carbon nanotubes and other nano shaped tip based emitters and also broad area emitters emerged. Recently, newer technologies like ballistic electron emitters and surface conduction emitters become available, each with their own advantages and disadvantages.

According to today's state of vacuum electron emitter technology, surface conduction emitters are among the best because they can operate at low voltage, offer low capacitance and their manufacturing procedure is rather simple. However, they have a major drawback: their electron emission efficiency (ratio of the current that reaches high voltage anode to the current that passes thin film emitter) is low and it exerts to use high current carrying electronic drivers and requires very low resistance conducting lines. (In the case of a matrix display, row lines will have to carry large current and their resistance should be preferably low)

Before going into detail about this novel approach, let's take a look at current status of surface conduction emitter. In today's surface conduction emitters, a thin planar conducting film is created. Then a nano gap is produced within this film. As a result, by applying a moderate voltage, one can create intense electric field around the fissure of this film and electron tunneling can occur from one side to another. However, the most intense lines of electric field are parallel to the film's plane in the fissure. As a consequence, tunneled electrons will accelerate parallel to thin film plane and they will collide with anode side of emitter and will be scattered.

Due to the fact that vectors of electric force around the active region of anode are downwardly facing anode, most of the accelerated electrons will have the tendency to remain in the anode plane which reduces probability of moving away from this plane and be emitted. (As can be seen in FIG. 4 as an illustration, one can imagine that scattered electrons around active region will be directed towards anode electrode instead of vacuum. (In this figure, curves are equipotential lines, arrows show estimated direction of electric force that will be induced on electrons and thick gray lines are anode and cathode of emitter).

In order to increase probability of electron emission to the vacuum (rather than absorption into the anode of emitter) the best thing to do is to alter electron trajectories in such a way that more electrons have a chance of escaping to the vacuum before even scattering in anode of emitter. Another thing we can do to increase electron emission efficiency is altering electric field around active region of anode in such a way that more scattered (or secondary emitted) electrons have a chance of escaping from anode's thin film into vacuum.

### SUMMARY OF THE INVENTION

This invention tries to increase electron emission efficiency by altering electric field around active region in order to improve electron emission efficiency. In order to make a better emitter that has low capacitance, low operating voltage and also high electron emission efficiency, a novel approach will be described here that can be called an evolution of surface conduction emitters. in this novel design, electron efficiency will be increased by affecting the shape of the active region of emitter in such a way that probability of electron absorption inside anode's thin film will be decreased and more electrons will be able to escape to vacuum from either ballistic electron emission, field emission or by lowering recurrence of scattering for an electron over the emitter film.

According to novel design of this invention, an electron emitting device that has a small fissure to realize electron emission is fabricated. Thin electrodes of anode and cathode of this novel emitter are not coplanar, instead they are placed on 2 intersecting surfaces and anode-cathode fissure is placed on top or near the top edge of these two intersecting surfaces. Preferably, the shape of the substrate around active region is a 3dimentional object with cylindrical shape with a cross section similar to triangle, bell shape or 2 intersecting parabolic curves (final shape of the substrate is somehow wedge shaped).

Other features and advantages of the instant invention will become apparent from the following description of the invention which refers to the accompanying drawings.

### BRIEF DESCRIPTION OF THE DRAWINGS

FIG. 1 shows a 3D view of an emitter according to an embodiment of the invention.

FIG. 2 shows a cross section of an emitter according to an embodiment of the invention.

FIG. 3A shows a cross section of an extended spindt substrate with a bell shaped cross section.

FIG. 3B shows a cross section of an extended spindt substrate with a cross section similar to two intersecting parabolic curves.

FIG. 3C shows a cross section of an extended spindt substrate with a triangular cross section.

FIG. 4 shows an electrostatic simulation of a prior art surface conduction electron emitter with co-planar structure.

FIG. 5 shows a cross section of an emitter according to an embodiment of the invention.

FIG. 6 shows an electrostatic simulation of an electron emitter according to an embodiment of the invention.

FIG. 7A shows an electrostatic simulation of a prior art surface conduction electron emitter with co-planar structure.

FIG. 7B shows an electrostatic simulation of an electron emitter according to an embodiment of the invention.

FIG. 8 shows a cross section of an electron emitter according to an embodiment of the invention that anode-cathode fissure is placed behind anode electrode.

FIG. 9 shows a cross section of an electron emitter according to an embodiment of the invention that both anode and cathode electrodes have an additional coating.

FIG. 10 shows a cross section of an electron emitter according to an embodiment of the invention that has a small fissure between anode and cathode electrodes on top of extended spindt substrate.

FIG. 11A shows a cross section of an electron emitter according to an embodiment of the invention that anode and cathode electrodes have the same height.

FIG. 11B shows a cross section of an electron emitter according to an embodiment of the invention that cathode electrode has lower height that anode electrode.

FIG. 11C shows a cross section of an electron emitter according to an embodiment of the invention that anode electrode has lower height that cathode electrode.

FIG. 12A shows a cross section of an electron emitter according to an embodiment of the invention with a small fissure between anode and cathode electrodes on top of an extended spindt substrate.

FIG. 12B shows a cross section of an electron emitter according to an embodiment of the invention with a small fissure between anode and cathode electrodes on the anode side of an extended spindt substrate.

FIG. 12C shows a cross section of an electron emitter according to an embodiment of the invention with a small fissure between anode and cathode electrodes on the cathode side of an extended spindt substrate.

FIG. 12D shows a cross section of an electron emitter according to an embodiment of the invention with a fissure between anode and cathode electrodes that cathode electrode is placed behind anode electrode.

FIG. 13A shows a cross section and a 3D view of a substrate according to a manufacturing step in fabrication of extended spindt substrate according to an embodiment of the invention.

FIG. 13B shows a cross section of a substrate according to another manufacturing step in fabrication of extended spindt substrate according to an embodiment of the invention.

FIG. 13C shows a cross section of a substrate according to another manufacturing step in fabrication of extended spindt substrate according to an embodiment of the invention.

FIG. 14A shows a cross section and a 3D view of a substrate according to a manufacturing step in fabrication of extended spindt substrate according to an embodiment of the invention.

FIG. 14B shows a cross section of a substrate according to another manufacturing step in fabrication of extended spindt substrate according to an embodiment of the invention.

FIG. 14C shows a cross section of a substrate according to another manufacturing step in fabrication of extended spindt substrate according to an embodiment of the invention.

FIG. 14D shows a cross section of a substrate according to another manufacturing step in fabrication of extended spindt substrate according to an embodiment of the invention.

FIG. 15 shows a 3D view of a substrate according to a manufacturing step in fabrication of extended spindt substrate according to an embodiment of the invention.

FIG. 16 shows a cross section of a substrate according to a manufacturing step in fabrication of electron emitter according to an embodiment of the invention.

FIG. 17 shows a 3D view of a mold that is used in a manufacturing step according to an embodiment of the invention.

FIG. 18 shows a 3D view of a substrate that is coated with a thin conducting ribbon according to a manufacturing step in fabrication of electron emitter according to an embodiment of the invention.

FIG. 19A shows a cross section of a substrate according to a manufacturing step in fabrication of extended spindt substrate according to an embodiment of the invention.

FIG. 19B shows a cross section of a substrate according to another manufacturing step in fabrication of extended spindt substrate according to an embodiment of the invention.

FIG. 19C shows a cross section of a substrate according to another manufacturing step in fabrication of extended spindt substrate according to an embodiment of the invention.

FIG. 19D shows a cross section of a substrate according to another manufacturing step in fabrication of extended spindt substrate according to an embodiment of the invention.

FIG. 19E shows a cross section of a substrate according to another manufacturing step in fabrication of extended spindt substrate according to an embodiment of the invention.

FIG. 20A shows a cross section of an unfinished emitter according to a manufacturing step in fabrication of electron emitter according to an embodiment of the invention.

FIG. 20B shows a cross section of an unfinished emitter according to another manufacturing step in fabrication of electron emitter according to an embodiment of the invention.

FIG. 20C shows a cross section of an unfinished emitter according to another manufacturing step in fabrication of electron emitter according to an embodiment of the invention.

FIG. 20D shows a cross section of an unfinished emitter according to another manufacturing step in fabrication of electron emitter according to an embodiment of the invention.

FIG. 20E shows a cross section of an unfinished emitter according to another manufacturing step in fabrication of electron emitter according to an embodiment of the invention.

FIG. 20F shows a cross section of an unfinished emitter according to another manufacturing step in fabrication of electron emitter according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

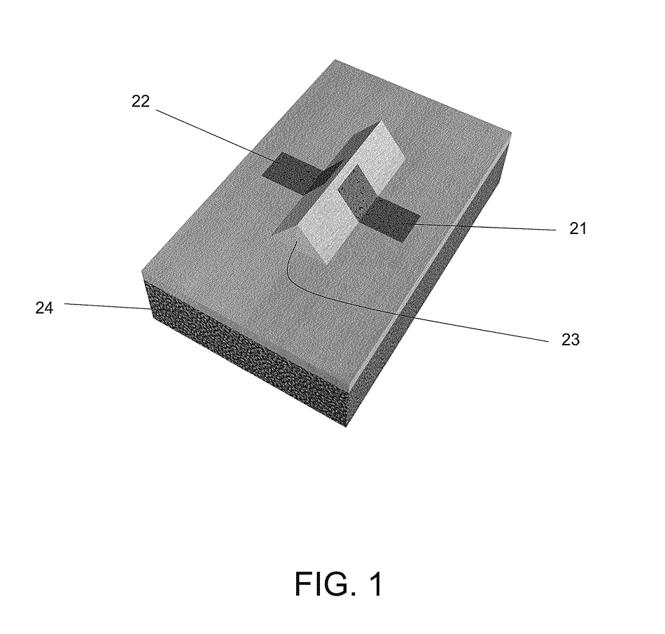

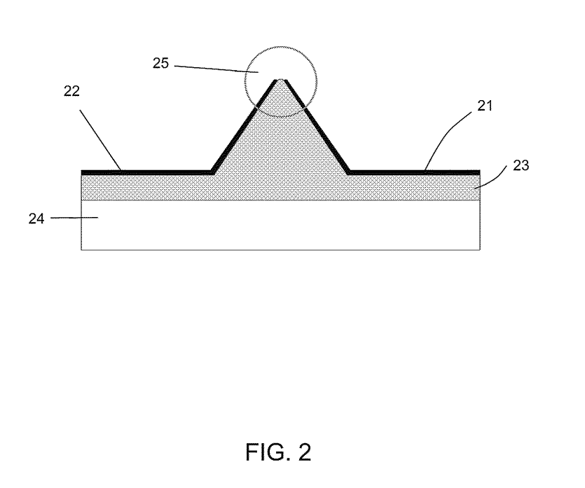

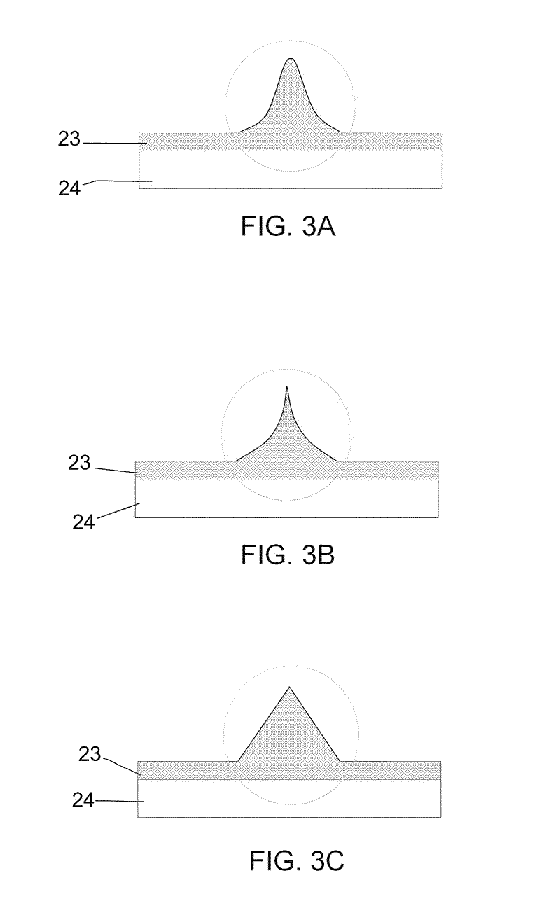

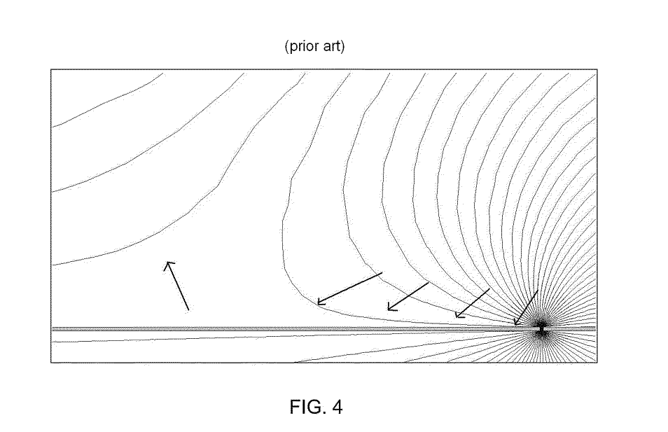

(Before talking about detailed description of the invention, couple of terms will be defined in order to prevent ambiguity:
Intersecting electrode electron emitter: general name of the emitter that will be proposed for this invention.
active region: active region in this patent is defined as the region near the fissure of anode-cathode in emitter that most intense lines of electric fields are present inside this region. In most of fissure based electron emitters, active region can be assumed to be the inner region of a circular cylinder with a diameter of about 1 micron which its axis is placed at the center of fissure. (as an example, active region is shown as 25 in FIG. 2)
Extended spindt substrate: substrate of emitter that has the shape of a 3D object that almost resembles a cylindrical shape with a bell shape or triangle cross-section. Preferable shape of this substrate is triangular prism with a sharp edge on top. The naming comes from the fact that it has a cross section similar to spindt emitter; however, instead of having a hemisphere shaped tip, it has a hemicylindrical edge on top and it's more like an extended spindt (wedge shaped) emitter (FIG. 1). Another reason for this naming is the fact that manufacturing method of spindt type emitters can be modified to fabricate these kinds of shapes. Its material can be an electrical insulator, insulator coated semiconductor or poor semiconductor and it's used as a substrate for consequent emitter electrode deposition and emitter creation. Different cross sections and couple of its shapes are available in FIGS. 3A, 3B and 3C. In this figure we can see a substrate with bell shaped cross section in FIG. 3A, cross section similar to 2 intersecting parabolic curves in FIG. 3B and triangular cross section as FIG. 3C)
Electron emission efficiency: ratio of the emitted current from film to vacuum to the total injected current to the thin film conductor.)

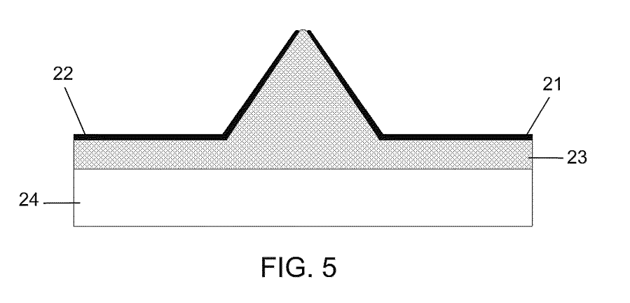

According to the present invention, the shape of active region is not planar and anode and cathode are thin electrodes that are placed on two intersecting surfaces (electrode thickness is preferably in the nanometer range up to couple of microns). As it can be seen in FIG. 5, the simplest shape is a 3D object that resembles a prism with triangular cross section (wedge shaped). In FIG. 5, cathode electrode is shown as 21 and anode electrode is shown as 22. both electrodes are placed on 2 different sides of a triangular prism-like substrate 23 that is placed on top of main substrate 24. Fissure of this emitter can be created on the top of this prism. As a result, active region of emitter is placed on top of this prism. It should be noted that shape of this emitter is not necessarily a prism; it's like a cylinder that its cross section can be a bell shape, intersection of two parabolic curves, a triangle or other similar shapes. The main concept and novelty of this invention is intersection of planes of anode and cathode electrodes near the top edge of this 3D object.

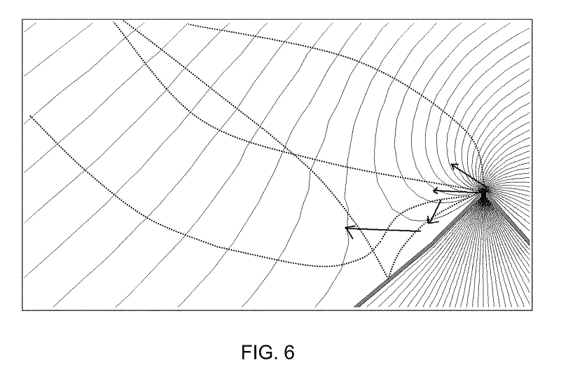

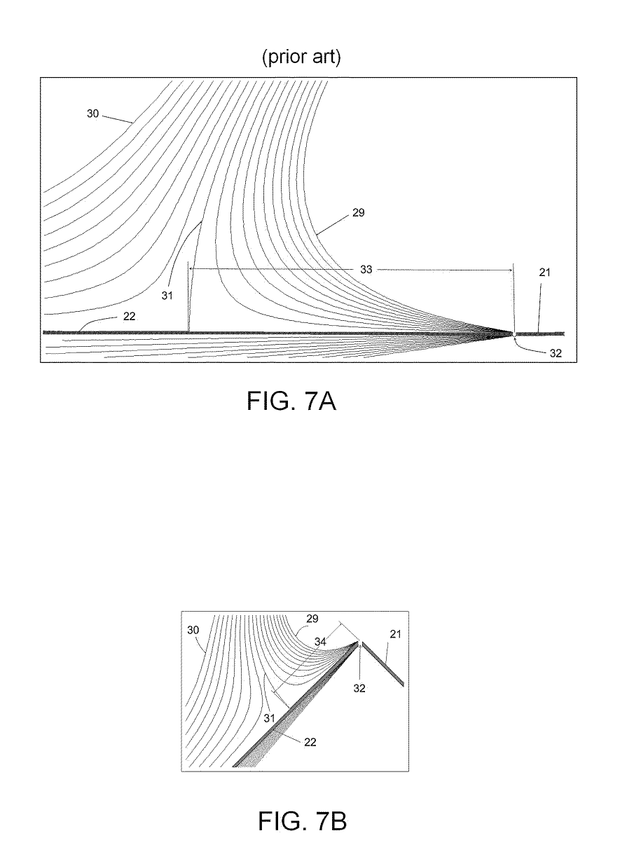

By taking a look at illustrative FIG. 6, we can see that electric field around fissure and active region has been altered in a productive way. In this new shape which anode and cathode are not coplanar, we can see couple of major benefits (N.B: in FIG. 6 as an illustration, curves are equipotential lines, arrows are showing estimated direction of electric force that will be induced on electrons, dotted lines are probable electron trajectories and thick gray lines are anode and cathode of emitter):
Some of tunneled electrons will be able to directly enter vacuum without even colliding with anode electrode.
Similar to a planar surface conduction emitter many electrons will scatter in anode and a portion of these scattered electrons and their induced secondary emitted electrons in anode will be able to break away from anode by multiple scattering phenomenon. Fortunately, probability of this kind of emission is also higher (compared to surface conduction electron emitter) because of the altered field around anode. This altered field around anode will vanish in a much closer distance from fissure, resulting in less scattering. In FIG. 7A and FIG. 7B, 32 is fissure, 29 represent “18” volts equipotential curve, 30 represent “22” volts and 31 represents 20 volts. By taking a look at FIGS. 7A and 7B that are results of simulation of two emitters that are placed in a chamber that also has a high voltage anode with voltage of 10 kV that is placed on top of emitter substrate with a distance of 1.6 millimeter and has an emitter fissure width 10 nm, film thickness 10 nm and film voltage=20 volts, we can see that in a co-planar surface conduction emitter, electric field vanishes in a distance of about 970 nanometers (shown as 33 in FIG. 7A) from fissure; however in the intersecting electrode emitter (with a triangular cross section with 5 microns height), field vanishes at 220 nanometers (shown as 34 in FIG. 7B) from fissure which is much lower than the co-planar emitter.

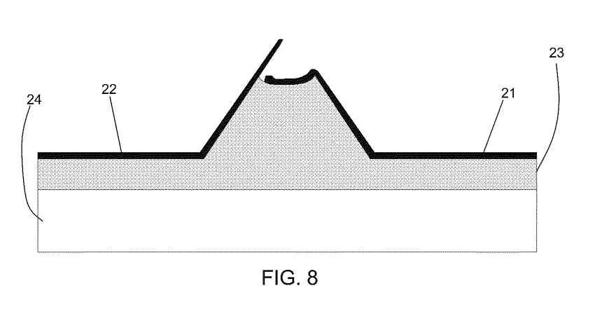

The main cause of electric field modification around anode is the fact that in this novel configuration, cathode's electrode is effectively shielded from upper surface of anode by anode itself and as a result, induced electric forces on electrons from anode's surface will become outwards after a shorter distance from fissure comparing to a planar surface conduction emitter.
In those designs that cathode lies behind anode electrode (as can be seen in FIG. 8 for example, Some of the emitted electrons will be able to pass through anode without losing much of their energy (like ballistic electrons), especially if one can reduce thickness of anode to a comparable length with mean free path of emitted electrons inside anode electrode. Some of these quasiballistic electrons will pass through anode and they will be able to escape from active region before scattering over anode surface. Remaining electrons will scatter on the surface of anode and portions of these scattered electrons will be able to jump to vacuum again.

Accompanying materials provided in this invention is categorized into two different sections:

first—Various points that will give details about this invention and its different embodiments are provided.

second—More detail about manufacturing methods for this invention is described based on those main points so one will understand this invention comprehensively.

First point: Types of intersecting electrode electron emitter: Generally speaking, one can divide this invention into two sub categories:

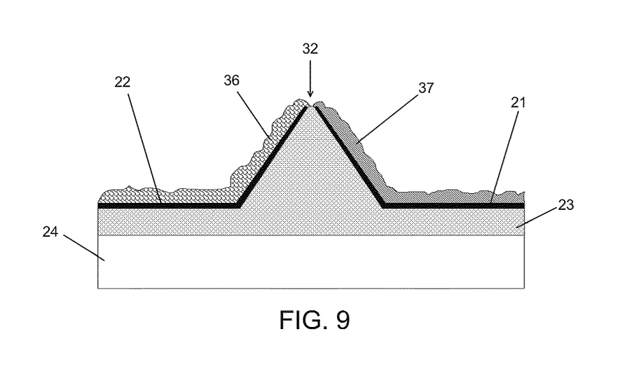

Wide fissure: in this design (FIG. 9), anode-cathode fissure on top of substrate will remain as is and in order to decrease threshold voltage, one might consider coating cathode side of emitter (shown as 37) to enhance field emission. In addition, designer might opt for coating anode (shown as 36) in order to increase secondary emission yield of anode surface to increase resulting electron emission efficiency.

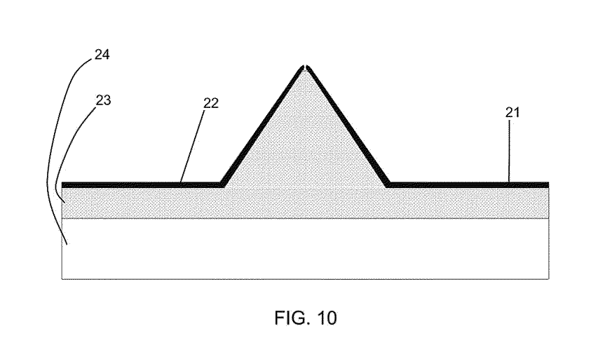

Small fissure: in this design, anode-cathode fissure on top of the substrate will be narrowed by activation process. Prior arts of surface conduction emitters contain lots of methods about how to narrow the gap in order to decrease its width (and will not be mentioned here). (FIG. 10)

Second point: Relative position of anode and cathode:

An important aspect in creating a good emitter is the shape of the edge of electrode of both anode and cathode. Because of the nanometer dimension of active region, small changes in the shape of anode or cathode can result in a different behavior of emitter.

Relative position of anode and cathode in wide fissure design:

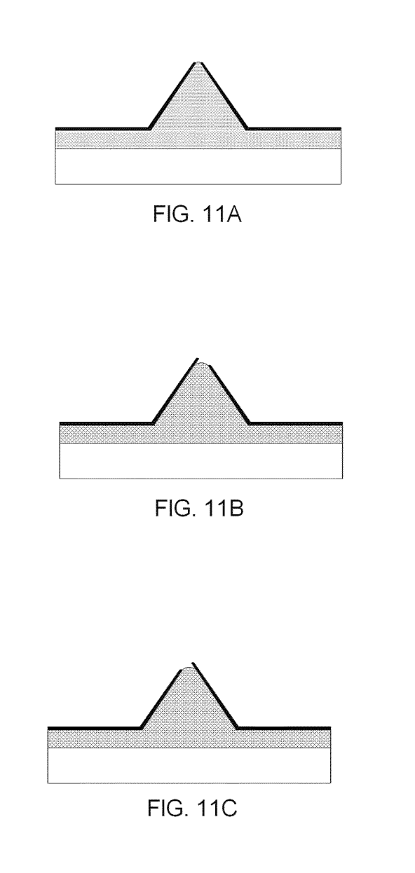

As can be seen in FIG. 11A to 11C, in this design we can categorize IE emitter into 3 groups:

1. Equal height of anode and cathode: shown as FIG. 11A.

2. Anode upper than cathode: shown as FIG. 11B.

3. Cathode upper than anode: shown as FIG. 11C.

Relative position of anode and cathode in small fissure design:

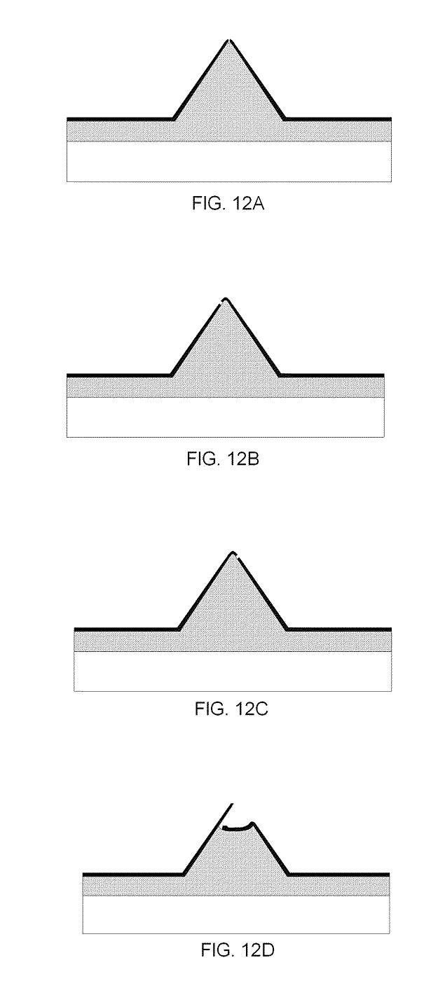

As can be seen in FIG. 12A to 12D, in this design, we can categorize IE emitter into 4 groups:

1. Fissure on top: fissure is on the top of the extended spindt substrate. It resembles a very small area surface conduction emitter. (shown as FIG. 12A)

2. Fissure on anode side: fissure is placed on the anode's plane and cathode is extended to reach anode. This design resembles an altered surface conduction emitter and because of the changed shape of electric field around anode, probability of electron emission will be increased comparing to a planar surface conduction emission. This fissure can be created by irradiation of an energetic narrow beam over anode side of emitter. (for example, ion, electron or laser beam) (shown as FIG. 12B)

3. Fissure on cathode side: this is the opposite design of “fissure of anode side” that can be seen (shown as FIG. 12C).

4. Fissure behind anode: (shown as FIG. 12D) in this design, fissure is created behind the anode electrode. In this design, with the use of a very thin film (1-100 nanometers) to act as anode electrode, we can observe ballistic electrons passing through anode film. In this design, the thinner the anode electrode, the better; because probability of ballistic electron emission will increase as we make anode's electrode thinner. (Very thin film semiconductors with near 1 nm thickness and metal films with just couple of nanometer thickness can be fabricated with ease by atomic layer deposition.) Finally, it is worth noting that it is also possible to create an opening in the anode electrode right over the fissure. in this case, more electrons will be able to pass through this opening and be emitted to vacuum.

Third point: Material selection and thickness of electrodes:

Material of anode and cathode electrode should be very thin (preferably in the order of nano meter up to couple of microns) and stable in high temperatures of FED manufacturing. Precious metals like platinum and gold seems to be good candidates. We might also consider using semiconducting material for electrodes, because they have a much higher resistance that can be useful as a ballast resistor in order to stabilize emitted current and in the case of a wide band gap semiconductor, it can be directly used (without additional coating on fissure) to act as the emitter. Oxide semiconductors (like zinc oxide) can be assessed in this case. Nitride semiconductors (like aluminum nitride with its low electron affinity) are also good emitters and might be a potential electrode material. Also, materials that are used in ordinary co-planar surface conduction electron emitters like palladium oxide can be considered, too.

Forth point: Narrowing the fissure gap:

Many method described in the prior art of surface conduction emitters can be used here in order to narrow the fissure gap. In a process that is called activation (that is usually done in an organic gaseous environment), one can reduce fissure width by filling it with carbon based material. In addition, electroplating might be used to coat anode or cathode (or both of them) with appropriate material. For example, we might coat anode with magnesium and cathode with zinc and later in an oxidizing environment, we can convert these two coating to their oxides. Magnesium oxide will enhance secondary electron emission yield over anode surface and zinc oxide can act as a good emitter over the cathode.

If we reduce fissure width, resulting emitter will be very similar to a surface conduction emitter and we can presume similar behavior with surface conduction emitters. As every skilled person in the art of surface conduction emitter knows, dominant emission mechanism in surface conduction emitters is multiple scattering. Those scattered electrons at fissure will scatter again and again on the top surface of anode until they either escape to vacuum or they will end up being absorbed into anode film.

If one can find a way to reduce recurrence of scattering over anode film; it can result in improved emission efficiency (because in each scattering, many electrons will be absorbed into anode). Fortunately, intersecting electrode emitter will reduce recurrence of scattering; because as it has been mentioned previously, downward force will diminish in a closer distance from fissure than in a co-planar surface conduction emitter and thus we will see less scattering and, by reducing recurrence of scattering in this novel intersecting electrode design, we can increase electron emission efficiency.

Fifth point: Some notes about insulation removal from the top edge of substrate:

As can be seen by simulation, most of the anode-cathode capacitance is related to charge accumulation in the active region especially on the anode and cathode sides that face extended spindt substrate. By removing this insulating edge in the final steps of manufacturing, we can reduce dielectric constant of materials near active and as a result, reducing capacitance of emitter.

Sixth point: Cathode coating:

In order to reduce work function of cathode's edge, one can coat it with appropriate material. Diamond like carbon is an interesting emitter. Semiconducting oxides like zinc oxides are also good candidates because of the ease of manufacturing. For example, zinc can be electroplated on cathode's electrode and later it can be oxidized to create zinc oxide coating. (Another benefit of an oxide based semiconductor is chemical stability and its inherit resistance against being attacked by residual oxygen). In the case of electroplating of cathode, we might need to immerse a main anode in our electrochemical bath to provide cations of metal like zinc based feeder anode.

Seventh point: Anode coating:

Contrary to cathode, edge of anode should be coated with a material that has a high work function. If we use platinum or gold as the electrode of anode, high work function is already achieved for the edge of anode and further coating seems to be unnecessary. Remaining surface of anode (other than its edge) should be coated with a material that aids secondary electron emission in order to increase emission efficiency of scattered electrons on the surface of anode. Many candidates with good secondary emission yield like magnesium oxide are available; other coating can be tried, too.

Manufacturing Methods:

Although we discuss a couple of manufacturing methods, it is recognized that other methods may be used as long as suitable to create the instant invention. These methods do not restrict other potential methods of manufacturing to fabricate this novel emitter.

In order to manufacture intersecting electrode electron emitter, a 3 module manufacturing method is used. A slightly different manufacturing method for the “fissure behind anode” design will be used.

First of all we have to create appropriately shaped substrate for electrode deposition. (A couple of appropriate shapes have been mentioned in this patent, but again it should be appreciated that other shapes are possible.)

Then thin film deposition and related lithography (or other patterning techniques) and etching will be used to define anode and cathode electrodes.

Finally, fissure will be created near the edge of anode-cathode and (if necessary,) fissure width will be reduced in order to enhance field emission around cathode's active region.

First step in manufacturing—Substrate creation:

In order to materialize aforementioned emitter, first of all, we have to create a non-planar substrate with two intersecting surface in order to later deposit a thin film on its surface to create anode and cathode of emitter (as defined earlier, it was named extended spindt substrate). Fortunately, thorough research has been done about spindt type emitters and as a result, fair knowledge about creating such sharp tipped 3D objects is available. It should be noted however that in most of prior arts, tip based conical objects with a nano hemisphere shaped apex have been created; nevertheless, related manufacturing ideas can be expanded and manipulated to create a cylindrical object (instead of a conical one) with a bell shape or triangle cross section that has a relatively sharp edge on top. Final shape of the substrate for such emitters will be something with a cross section similar to those in FIG. 3A to 3C. To give an idea about how to manufacture such extended spindt substrate, 4 methods will be discussed here:

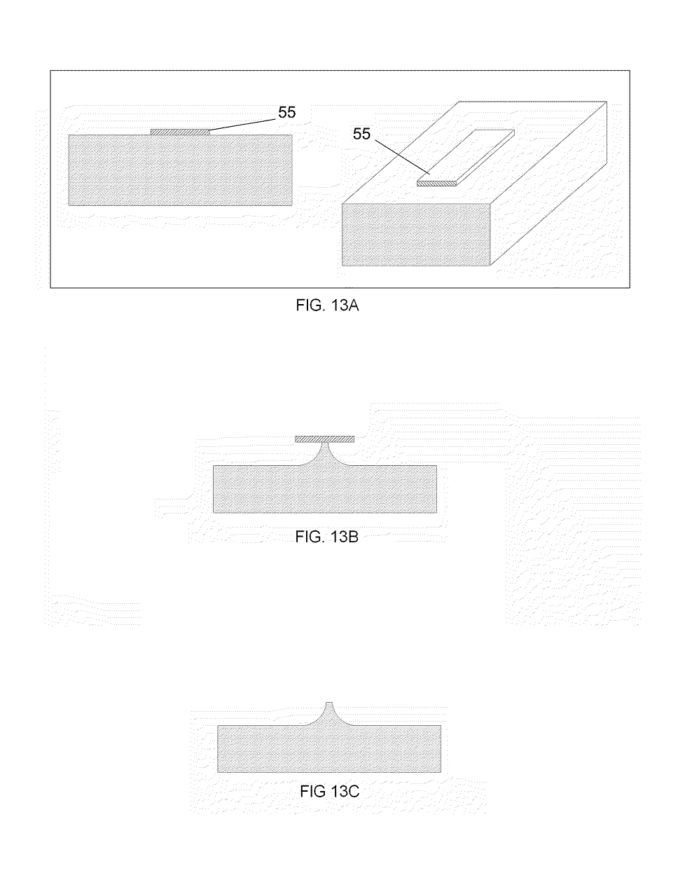

1. Direct etching method: This method of manufacturing such a substrate can be described as (in FIG. 13A to 13C):
(optional) A thin homogeneous insulating layer is deposited on top of the main substrate of device (for example, back plate of field emission display). In the case of glass substrate, we might be able to omit this step and we can use the main glass as the insulator of extended spindt substrate. Thickness of this layer can be anything from sub micron up to tens of microns. It's recommended that thickness of this layer be more than the height of extended spindt substrate. For example, if the height of prism like substrate is going to be 5 microns, it's recommended to deposit an insulating film with a thickness more than 5 microns in order to provide enough material for subsequent etching process (to be described later). In addition, deposition technique that is used should provide a homogeneous layer with least amount of pores. Creating a single crystal structure seems to be impractical over large areas and amorphous or polycrystalline structures are more feasible. Many mature techniques like CVD are available for a controlled thin film deposition that can be used here. Material of this film is preferably a good insulator like aluminum oxide or silica.
(Optional) chemical mechanical planarization method is used to flatten and polish surface of the deposited layer
A photoresist mask 55 is added and patterned on top of the insulating layer in order to protect top of the substrate from etching. Shape of this pattern will be preferably a narrow rectangle.
Etchant material (preferably isotropic etchant) is applied and etching will start to corrode deposited material from every side expect the areas that are protected by photoresist mask and after a while, a substrate with a cross section similar FIG. 13B will be created as a result of underetching with a relatively sharp edge on top of it.
Photoresist mask is removed. Final piece will look similar to FIG. 13C.

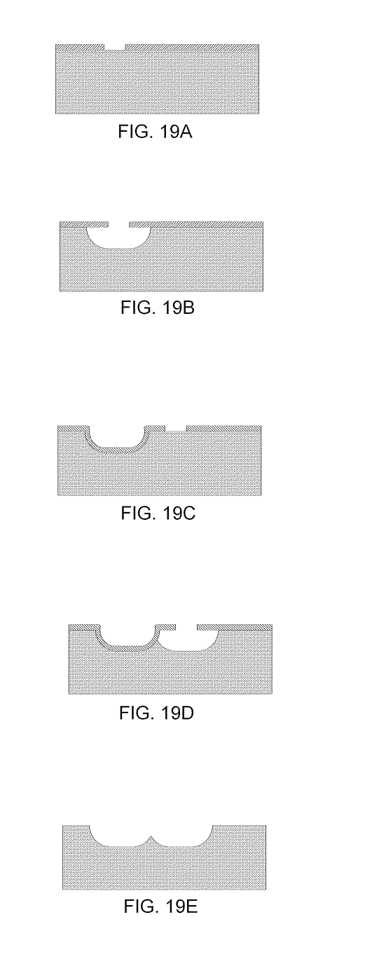

2. Double etching method: in direct etching method described before, imperfect manufacturing and tolerances will result in a blunt top edge that is not suitable. To resolve this, we use a double step etching method as shown in FIG. 19A to 19E as follows. This method is useful in creating wedge like emitters as well.
Photoresist mask is added and patterned with a rectangular hole in it (shown as FIG. 19A.)
Etchant is applied and it will corrode substrate and it will create a hemicylindrical hole inside substrate (shown as FIG. 19B.)
Photoresist mask is removed and another fresh layer of photoresist is added and will be patterned with a rectangular hole in it near the previous hole over substrate (shown as FIG. 19C.)
Etchant is applied and it will corrode substrate and it will create another hemicylindrical hole inside substrate (shown as FIG. 19D.)
Mask is removed. Final piece will look similar to FIG. 19E.

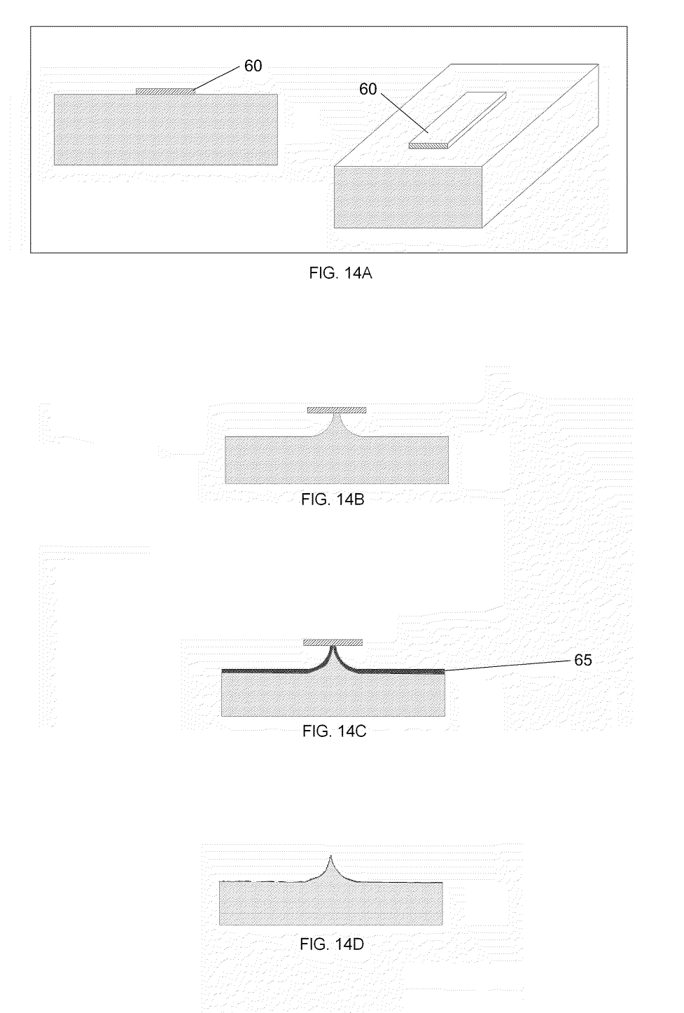

3. Silicon oxide sharpened substrate (FIG. 14A to 14D):
A silicon layer is deposited on main substrate.
A photoresist mask is added and patterned on top of the insulating layer in order to protect top of the substrate from etching. Shape of this pattern will be preferably a narrow rectangle. (Shown as 60 in FIG. 14A)
Etchant material (preferably isotropic etchant) is applied and etching will start to corrode deposited material from every side expect the areas that are protected by photoresist mask and after a while, geometry similar to FIG. 14B will be created with a relatively sharp edge on top of it.
By oxidizing, we can fabricate even sharper edge on top of substrate. (As Shown in FIG. 14C. In this figure we can see oxide layer 65 sharpens the top edge of substrate.).
Photoresist mask is removed.
Silicon oxide layer is removed. (Shown as FIG. 14D)
If necessary, an oxide layer will be deposited over entire remaining silicon surface or the silicon itself is converted to silicone oxide by methods like thermal oxidation or anodizing. This oxide layer might be helpful to decrease leakage current between later-to-be-deposited anode and cathode electrodes because silicon itself is a semiconductor and not an insulator but silicon oxide is a well known insulator.

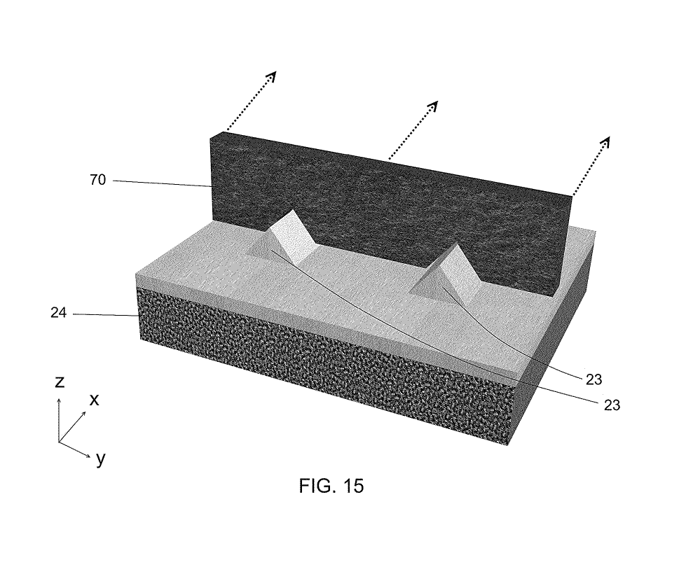

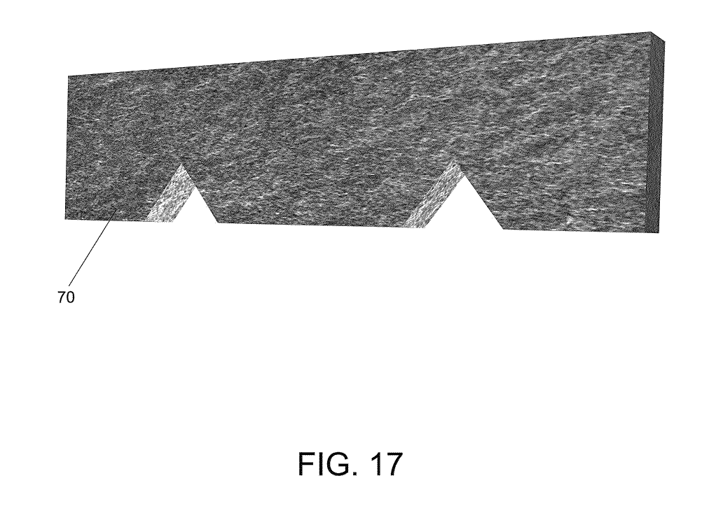

3. Direct sol-gel mold: in this method, we will use small molds with repetitive teeth that resemble a rack (shown as 70 in FIG. 17) and a sol-gel precursor to fabricate extended spindt substrate. One simple method can be the use of a comb shaped mold that glides over entire area of a sol-gel coated substrate. In this method as can be seen in FIG. 15:
Sol-gel precursor is deposited over entire area of main substrate.
Properly shaped rack-like mold will be moved over sol-gel layer. (The mold 70 will glide over sol-gel precursor along the “X” axis according to FIG. 15. Dotted arrows show direction of movement.)
Fabricated cylindrical shape will dry and solidify, resulting in extended spindt substrate.

Again the above substrate manufacturing methods are just examples of how to make an extended spindt substrate for emitter deposition that has a sharp edge on top. Other methods can be extrapolated from prior arts of spindt tip emitter manufacturing or other novel ideas might be devised in order to make similarly shaped substrates for emitter deposition.

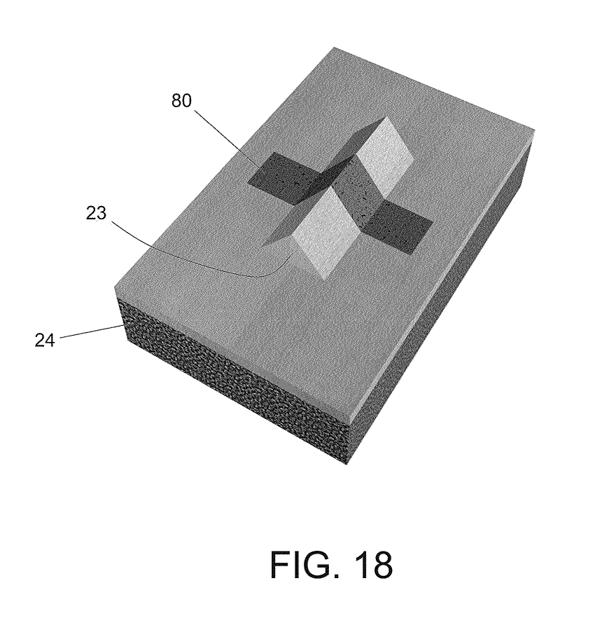

Second step in manufacturing—Anode & cathode thin film deposition: After creating that extended spindt substrate, we can deposit a thin layer of conducting material on its surface and by traditional photolithography (or many other pattering techniques like imprinting or silk screening) and etching methods, we can define appropriate pattern on this conducting film to later convert it to electron emitter. Something like FIG. 18 will be created after these steps. As can be seen in FIG. 18, this semi-final emitter consists of a sharp edge substrate and a thin continuous layer of patterned conducting (or semi conducting) material 80.

Third step in manufacturing—Creating fissure on top: Numerous methods have been described in the art of surface conduction emitter manufacturing that can be used here on order to create a fissure and later reduce the width of the gap of fissure; for example, we might coat a thin film PdO over substrate and later we can create a sub micron crack by forming process and later in activation process, we can reduce width of this gap. Methods like this have been covered in prior arts and won't be mentioned anymore in this patent BUT can be used here, too. Nevertheless, because of the special shape of this emitter, couple of NOVEL methods can be used to create a fissure on top of sharp edge substrate. We can separate these novel methods into 2 major groups:

1. Direct material removal: in this method, portion of conducting (or semiconducting) film that is placed on top of the edge will be removed directly. For example, chemical mechanical planarization can be used to remove thin film from top edge of emitter.

2. Indirect material removal: in this method, we first coat thin film with a protective mask. Then we remove the mask from top of the edge and finally, we expose this patterned mask to etchant to remove unprotected thin film.

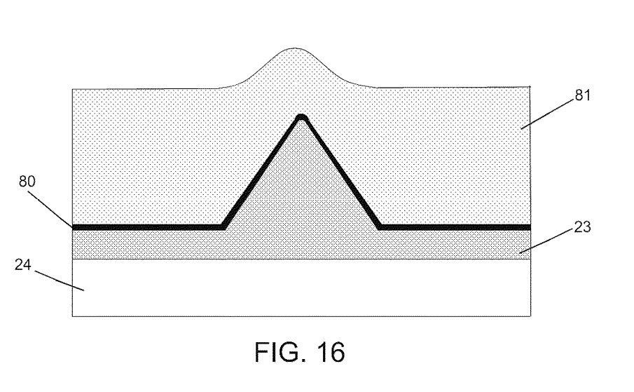

In both aforementioned methods, we have to selectively remove either main film or protective mask from the top edge of emitter. In order to do so, we might consider couple of methods like:
Chemical mechanical planarization edge removal: in this method, one can remove conducting layer or protective mask on top of the edge of substrate by using chemical mechanical planarization because height of the edge is higher that the base plane and as a result, more material will be removed from top of the shape. In order to better harness this method, we can add a temporary layer to fill the gaps around the edge and then we can apply this method, and finally we can remove this temporary filler. By doing so, we will reduce troubling material removal from other parts of conducting layer than the top edge. (FIG. 16) An inexpensive and simple material can be calcium sulfate (gypsum). This filler 81 can be added before edge removal and later it can wiped away by a solvent that in the case of gypsum it can be water.
Field emission enhanced (or ion enhanced) material removal: by applying appropriate voltage to the deposited thin film conductor, partial discharge or even field emission will occur on top of the sharp edge of conducting layer. In addition, very strong electric field is created on top of the edge. We can harness these phenomena in an environment that is filled with appropriate gases like SF6, chlorofluorocarbons, NF3 and oxygen as an example. In such an environment that we apply enough electrical potential to this sharp electrode in the presence of reactive gases, partial discharge can occur and ionization of gases take place around this sharp edge. This can result in attracting reactive radicals and ions to top of the emitter. These radicals can react with the conducting material or protective mask and remove it from there.

In the case of direct material removal, it can convert it to insulating material, thereby gradually corroding it and transfer it to an extremely thin layer conductor. After that, an impulse current can be applied to remove remaining material by fusing mechanism. Finally, remaining debris can be detached by chemical solvents. As another example, we can coat thin film with an electron beam resist. in this case, by emitting electrons from sharp edge of emitter, we can alter the resist around the emitting edge; In the case of a positive resist, those unaffected areas of mask will protect underneath layer and exposed areas at top edge will dissolve and their underneath layer can be removed by etchant.
Heat induced material removal: due to the physical shape of the patterned film, if we pass current through it, top edge of this film will become hotter than other places. We can harness this phenomenon to affect thin film around edge. For example, this heat can be used to fuse thin film, or it can be used to oxidize thin film around the edge, or it can initiate a chemical reaction in an appropriate environment for example in the presence of SF6 gas, it can decompose SF6 and resulting fluorine gas will react with most metals and semiconductors and create volatile materials that will be removed with ease.
Hybrid method: combination of the above-mentioned methods can be used for instance, field emission and heat and chemical reaction can be used altogether. As an example, emitted electrons and intense electric field around edge can break surrounding gas (that preferably contains fluorine). These fluorine radicals or ions will react with heated thin film and will remove the film from there. Reaction will stop right after a gap is created because there won't be any circuit to carry current. Thus it's a self limiting reaction.

Additional method of manufacturing “fissure on top emitter”, based on substrate volume change: We can harness volume change of extended spindt substrate as a result of temperature change or oxidation to create fracture in the thin film on top of the substrate by following methods:
Thermal expansion (or contraction) induced fracture: if the substrate has a higher coefficient of thermal expansion than the thin film that has been deposited on top of it, as a result of increased temperature it will expand more than the thin film. This phenomenon will result in a fracture in weakest part of the film that in this case, will be the region near top of the substrate. (Film around the top can be made thinner by polishing if needed). For example, we can create a metal based substrate and deposit a ceramic thin film over it and heat them up to generate a crack on the film. Contrary to this, we might use a thin film made of a metal coated on a ceramic substrate and by cooling them enough, fracture will be produced in the metallic film near the top edge.
Oxidation expansion induced fracture: oxidation will usually result in the expansion of material. Silicon oxidation and aluminum oxidation are among two examples of this phenomenon. Like the previous method, we can harness this induced expansion to create a fracture on top of the thin film. In order to do so, we first deposit thin film over substrate and later, we expose substrate to oxidation that will result gradual oxidation of substrate, thereby increasing its volume. This increased volume will result in tensile stress in the thin film over substrate, tearing it apart on top.

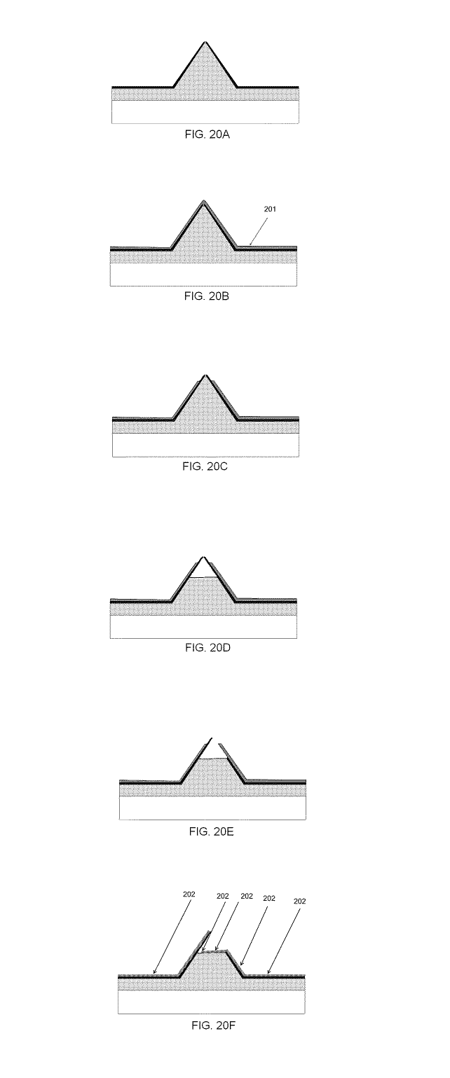

Method of manufacturing “fissure behind anode” emitter: As shown in FIG. 20A to 20F, In order to manufacture this type of emitter, (after substrate creation, thin film deposition and creating fissure on top) we can add couple of additional steps in order to complete fabrication:
A protective mask (shown as 201 in FIG. 20B) is coated over entire surface of panel.
Protective mask around top of the fissure if removed by for example, chemical mechanical polishing as shown in FIG. 20C.
Material of the extended spindt substrate is removed by etchant to create a well inside top of the substrate to expose inner side of thin film as shown in FIG. 20D.
While cathode side of thin film is being dissolved by chemical solvent or electro polishing method, anode side of fissure in protected by catholic protection as shown in FIG. 20E. After that, we can remove protective mask.
Gap between anode and cathode is closed by methods like activation (known in the literature of surface conduction emitter—not shown) or by the use of extremely directional sputtering. In the latter case, we can deposit a thin film by controlled and directional sputtering (direction of sputtering is shown as 202 in FIG. 20F). As a result, parts of the top side of substrate will not be covered by thin film (because of shadowing effect of anode film), resulting in a gap between anode and cathode.
(Optional) by applying appropriate DC, AC or impulse voltage between anode and cathode electrodes, we can create hot plasma between cathode's edge and anode's film to remove anode material and create a hole or fissure inside anode's film in order to let more electrons escape from cathode to vacuum. As an alternative, we can coat anode's film with a positive e-beam resist and by exposing it to tunneled electrons from cathode, we can alter and remove the resist mask from exposed area and later, we can dissolve unprotected areas of anode's film by etchant. This method will also result in a fissure near cathode's edge in anode's film.

Although the instant invention has been described in relation to particular embodiments thereof, many other variations and modifications and other uses will become apparent to those skilled in the art.

What is claimed is:

1. An electron emitter whereby high electron emission efficiency is realized comprises:
an extended spindt substrate;
two intersecting electrodes disposed on said extended spindt substrate for an anode electrode and a cathode electrode; and
an active region with a fissure near top edge of said cathode and anode electrodes whereby electron emission is realized therein.

2. An electron emitter according to claim 1 wherein said extended spindt substrate has a triangular cross section.

3. An electron emitter according to claim 1 wherein said extended spindt substrate has a bell shaped cross section.

4. An electron emitter according to claim 1 wherein said extended spindt substrate has a cross section with the shape of intersection of two parabolic curves.

5. An electron emitter according to claim 1 wherein said fissure is placed behind said anode electrode.

6. An electron emitter according to claim 1 wherein said fissure has been narrowed by an activation process in a gaseous environment.

7. An electron emitter according to claim 1 wherein said anode electrode has an additional coating.

8. An electron emitter according to claim 1 wherein said cathode electrode has an additional coating.

9. A method of manufacturing an extended spindt substrate that comprises the steps of:
preparing a substrate for surface treatments;
applying a mask over said substrate;
underetching said substrate; and
removing said mask whereby said extended spindt substrate is created.

10. A method of manufacturing an extended spindt substrate according to claim 9 wherein the step of preparing a substrate for surface treatments further comprises the step of applying a silicon coating over said substrate.

11. A method of manufacturing an extended spindt substrate according to claim 10 wherein the step of underetching said substrate further comprises the step of oxidizing said silicon coating.

12. A method of manufacturing an extended spindt substrate that comprises the steps of:
preparing a substrate for surface treatments;
applying a mask with predefined holes therein over said substrate;
underetching said substrate;
removing said mask;
applying a fresh layer of mask with predefined holes therein over said substrate;
underetching said substrate within the newly defined holes in the said fresh mask; and
removing said fresh mask whereby said extended spindt substrate is created.
